(19) United States
(12) Patent Application Publication
(10) Pub. No.: US 2026/0177144 A1
(43) Pub. Date: Jun. 25, 2026

(54) 2-SPEED TRANSFER CASE WITH SINGLE ACTUATOR

(71) Applicant: HYUNDAI WIA CORPORATION, Changwon-si (KR)

(72) Inventor: Su Whoan LEE, Uiwang-si (KR)

(21) Appl. No.: 19/426,430

(22) Filed: Dec. 19, 2025

(30) Foreign Application Priority Data
Dec. 24, 2024 (KR) 10-2024-0195619

(51) Int. Cl. F16H 63/30; B60K 17/344; B60Q 9/00; F16H 3/00; F16H 3/44; F16H 59/68; F16H 61/12; F16H 63/32; G07C 5/08

(52) U.S. Cl. CPC F16H 63/304; F16H 59/68; F16H 61/12; F16H 63/3013; F16H 63/32; G07C 5/0808; G07C 5/0825; B60K 17/344; B60Q 9/00; F16H 2003/007; F16H 3/44; F16H 2003/445; F16H 2059/6807; F16H 2063/3056; F16H 2200/0013; F16H 2200/0034; F16H 2200/2005

(57) ABSTRACT

The present disclosure provides a two-speed transfer case with a single actuator that may implement both the fork axial movement function and the ball ramp operation function by using the single actuator, and can accurately identify the butting or failure state by determining the angular difference before and after the torsion spring through the MR sensor of the motor, the position sensor that directly detects the axial position of the fork, or the angle sensor that directly measures the rotation angle of the cylindrical cam.

This application claims priority to and the benefit of Korean Patent Application No. 10-2024-0195619, filed on 2024 Dec. 24, the disclosure of which is incorporated herein by reference in its entirety.

### BACKGROUND

### Technical Field

Embodiments of the present disclosure relate to a 2-speed transfer case, more particularly, a two-speed transfer case with a single actuator that may implement both a fork axial movement function and a ball ramp operation function by using the single actuator, and may accurately identify a butting or failure state by determining the angular difference before and after a torsion spring through a MR sensor of a motor, a position sensor configured to directly detect the axial position of the fork, or an angle sensor configured directly measure the rotation angle of the cylindrical cam.

### Background of the Disclosure

A 2-speed transfer case applied to 4-Wheel-Drive vehicles is responsible for functions such as power transmission/cutoff from main drive wheels to auxiliary drive wheels (2WD-4WD conversion) and torque transmission amount control, and vehicle driving force amplification (in LOW mode) through switching between HIGH mode (1:1 gear ratio) and LOW mode (approximately 2.xx:1 reduction gear ratio).

For high-low switching, a sleeve configured to move integrally with a shift fork while the shift fork moves axially is controlled to be coupled to an input shaft or planetary gear. In addition, for 2WD-4WD switching, a ball ramp mechanism is applied to the wet multi-plate clutch system, and the axial stroke generated through the ball groove according to the rotation of the ball ramp is controlled to pressurize a wet multi-plate clutch.

Conventionally, two actuators were provided to perform the 2WD-4WD switching function and the high-low switching function, respectively. Specifically, U.S. Pat. No. 5,407,024 A separately provides a motor actuator 100 for fork control for high-low switching and electromagnetic actuators 142 and 144 for ball ramp control for 2WD-4WD switching.

Furthermore, U.S. Pat. No. 10,471,826 B2 discloses a transfer case with a common actuator system for both fork control for high-low switching and ball ramp control for 2WD-4WD switching. In other words, a single motor 364 performs both ball ramp control and fork control.

However, conventionally, DC motors controlled by voltage or current control are used, making motor angle measurement impossible. Furthermore, product status (butting or normal engagement) is estimated due to increased load current. This poses a problem in that there is a possibility of misjudgment due to differences in temperature or motor efficiency.

Furthermore, conventionally, a position sensor 369 is positioned to detect the rotation of a sensor plate 392 configured to be driven by a gear plate 396. However, in this case, since the position sensor 369 is positioned in front of the torsion spring 386 in the actuating power transmission flow, i.e., because it detects the rotation of the sensor plate 392 located in front of the torsion spring 386, there is a problem in that the position sensor 369 cannot accurately determine the positions of the shift fork 382 and reduction hub 322 where the gear is actually engaged. Specifically, during gear butting, despite the rotation of the sensor plate 392, there may be cases where the shift fork 382 and reduction hub 322 do not move in position and the torsion spring 386 receives force.

Since the position sensor does not directly sense the position of the gear-engaged component, it cannot accurately measure the actual position of the shift fork, reducing the reliability of determining whether the high-low shift has been engaged.

Furthermore, if the component at the rear of the torsion spring breaks during transfer case operation, it cannot be recognized. The components at the rear of the torsion spring are related to the main drivetrain within the vehicle and are therefore highly critical for safety.

### SUMMARY

Accordingly, one object of the present disclosure is to provide a two-speed transfer case with a single actuator that may implement both the fork axial movement function and the ball ramp operation function by using the single actuator, and can accurately identify the butting or failure state by determining the angular difference before and after the torsion spring through the MR sensor of the motor, the position sensor that directly detects the axial position of the fork, or the angle sensor that directly measures the rotation angle of the cylindrical cam.

The objects of the present disclosure are not limited to those mentioned above, and other technical objects may be inferred from following embodiments.

To solve the objects of the present disclosure, according to an embodiment of the present disclosure, a 2-speed transfer case may include a motor comprising an MR sensor that is embedded therein configured to measure the rotational angle of a motor; a reduction unit connected to the motor; a reduction gear connected to the reduction gear; a camshaft coupled to the center of the reduction gear and rotating integrally with the reduction gear; a lever cam installed on the cam shaft and rotating integrally with the cam shaft; a cylindrical cam installed coaxially with the lever cam; a torsion spring unit disposed between the lever cam and the cylindrical cam and configured to transmit the rotation of the lever cam to the cylindrical cam; a fork configured to move axially along a cam groove of the cylindrical cam; and an angle sensor configured to measure the rotational angle of the cylindrical cam.

According to the embodiments, the torsion spring unit may include a first torsion spring and a second torsion spring that are arranged coaxially in parallel, and a bushing configured to connect the first torsion spring and the second torsion spring.

According to the embodiments, the bushing may be formed in a cylindrical shape and disposed inside the first torsion spring and the second torsion spring.

According to the embodiments, one directional rotation of the lever cam may cause one directional rotation of the first torsion spring and the other-directional rotation of the lever cam may cause the other-directional rotation of the second torsion spring, and one directional rotation of the second torsion spring may cause one directional rotation of the cylindrical cam and the other-directional rotation of the first torsion spring may cause the other-directional rotation of the cylindrical cam.

According to the embodiments, the lever cam may include a first bending portion that protrudes radially outward and is bent toward the cylindrical cam, and the cylindrical cam may include a second bending portion that protrudes radially outward and is bent toward the lever cam. The first torsion spring may include a first extension portion that extends to face both one side of the first bending portion and one side of the second bending portion, and the second torsion spring may include a second extension portion that extends to face both the other side of the first bending portion and the other side of the second bending portion.

According to the embodiments, the angle sensor may be coaxially connected to the cylindrical cam.

According to the embodiments, the lever cam and the torsion spring portion may be arranged closer to the reduction gear than the cylindrical cam, and the angle sensor may be arranged farther from the reduction gear than the cylindrical cam.

According to the embodiments, the 2-speed transfer case may further include a cam gear arranged coaxially with the reduction gear and configured to rotate together with the reduction gear only during a certain rotational range; and a ball ramp configured to operate according to the rotation of the cam gear and generate an axial stroke. In the rotation section of the reduction gear in which the fork moves axially, the reduction gear and the cam gear may not engage, and in the rotation section of the reduction gear in which the fork does not move axially, the reduction gear and the cam gear may engage.

According to the embodiments, the reduction gear may include a plate having a gear formed on the outer periphery thereof to engage with the reduction unit, and a protrusion portion protruding from the plate toward the cam gear. The cam gear may include a cylindrical portion having a gear formed on the outer periphery thereof to engage with the ball lamp, and a space portion formed inside the cylindrical portion in the circumferential direction with respect to the rotational section of the reduction gear in which the fork moves axially, and in which the protrusion is accommodated.

According to the embodiments, the reduction unit is a worm gear.

According to the embodiments, the reduction unit is a spur gear set.

According to the embodiments, the 2-speed transfer case may further include a control unit configured to determine whether the 2-speed transfer case is in a butting state where the rotation of the lever cam is not completely transmitted to the rotation of the cylindrical cam or whether the 2-speed transfer case is in a failure state by using the rotation angle of the motor measured by the MR sensor and the rotation angle of the cylindrical cam measured by the angle sensor.

The control unit may calculate the rotation angle of the reduction gear by considering the rotation angle of the motor and the gear ratio from the motor to the reduction gear, and compare the rotation angle of the reduction gear with the rotation angle of the cylindrical cam.

According to the embodiments, the control unit may determine that the butting state is present if the difference between the rotation angle of the reduction gear and the rotation angle of the cylindrical cam is 5° or more and 160° or less in the rotation section of the reduction gear in which the fork moves in the axial direction.

According to the embodiments, the control unit may determine that the failure state is present if the difference between the rotation angle of the reduction gear and the rotation angle of the cylindrical cam exceeds 160° in the rotation section of the reduction gear in which the fork moves in the axial direction.

According to the embodiments, if the control unit determines that the butting state is present, it displays the occurrence of butting on a vehicle's cluster.

According to the embodiments, the control unit may turn on the vehicle's warning light when it determines that the failure state is present.

According to the embodiments, the control unit may determine that the failure state is present if the difference between the rotation angle of the reduction gear and the rotation angle of the cylindrical cam is 12° or more in the rotation section of the reduction gear in which the fork does not move axially.

According to the embodiments, in order to align the cam shaft and the reduction gear when the rotation angle of the motor is 0°, the cam shaft may comprise a tooth alignment protrusion, and the reduction gear comprises a tooth alignment groove into which the tooth alignment protrusion is inserted.

According to the embodiments, in order to align the cam gear and the ball ramp when the rotation angle of the motor is 0°, the cam gear and the ball ramp each may comprise alignment marks.

According to the present disclosure, a single actuator may be used to implement both fork axial movement and ball ramp operation.

Furthermore, the precise position of the fork can be determined by directly detecting the position of the fork moving axially for high-low switching using a position sensor, or by directly measuring the rotational angle of the cylindrical cam using an angle sensor.

Furthermore, the rotational angle of the motor can be measured using the MR sensor built into the BLAC motor. This allows comparison between the rotational angle of the reduction gear, calculated from the motor rotational angle, and the rotational angle of the cylindrical cam, calculated from the fork's axial stroke or measured directly. In other words, the angular difference before and after the torsion spring can be determined. This allows for accurate identification of butting state, where the torsion spring is under force and the rotation of the lever cam is not fully transmitted to the cylindrical cam, preventing the fork from moving to the target position, or failure state in which the switching component is damaged.

However, it should be understood that the detailed description and specific examples, while indicating preferred embodiments of the disclosure, are given by illustration only, since various changes and modifications within the spirit and scope of the disclosure will become apparent to those skilled in the art from this detailed description.

### DESCRIPTION OF DRAWINGS

FIG. 1 is a perspective view illustrating a two-speed transfer case having a single actuator according to an embodiment of the present disclosure;

FIG. 2 is a perspective view of FIG. 1, excluding the housing;

FIG. 3 is a perspective view of FIG. 2, excluding some components, viewed from a different angle;

FIG. 4 is a perspective view of a portion of FIG. 3, excluding the second torsion spring, viewed from a different angle;

FIG. 5 is an enlarged perspective view of a portion of FIG. 3, viewed from a different angle;

FIG. 6 is an exploded perspective view of FIG. 2, showing the reduction gear and cam gear separated;

FIGS. 7a to 7c are cross-sectional views illustrating the arrangements of the reduction gear and cam gear;

FIG. 8 is a side view of the camshaft portion of FIG. 2, viewed from the right.

FIG. 9 is a side view of the cam gear and ball ramp portion of FIG. 2, excluding the reduction gear, as viewed from the right;

FIG. 10 is a front view of a portion of a two-speed transfer case having a single actuator according to another embodiment of the present disclosure; and

FIG. 11 is a perspective view of FIG. 10.

### DESCRIPTION OF SPECIFIC EMBODIMENTS

Hereinafter, a preferred embodiment of a two-speed transfer case having a single actuator of the present disclosure will be described with reference to the attached drawings.

In addition, the terminology used herein is for the purpose of describing embodiments only and is not intended to be limiting of the present disclosure. In this specification, the singular also includes the plural unless the context clearly dictates otherwise.

In order to clearly explain the present disclosure, parts irrelevant to the description have been omitted, and the same reference numerals are used for identical or similar components throughout the specification. Throughout the specification, when a part is said to “comprise” “include” a certain component, this does not mean that other components are excluded, but rather that other components may be additionally included, unless specifically stated otherwise.

In addition, components expressed as “part”, “unit” and “portions” throughout the disclosure may be two or more components combined into one component, or one component may be divided into two or more components with more detailed functions. In addition, each component described below may additionally perform some or all of the functions performed by other components in addition to its own main function, and of course, some of the main functions performed by each component may be performed exclusively by other components.

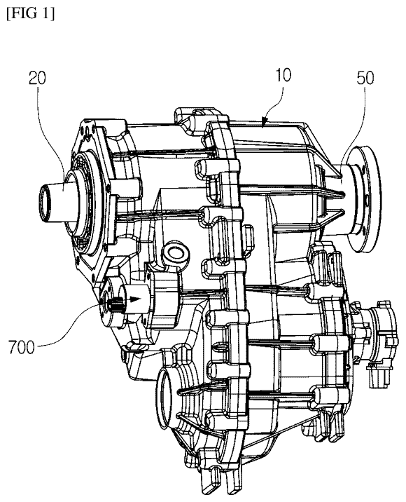

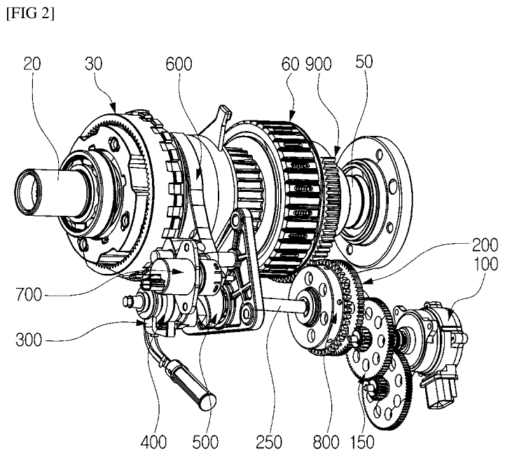

First, referring to FIGS. 1 and 2, a two-speed transfer case according to an embodiment of the present disclosure will be described.

The two-speed transfer case of the present disclosure may include a housing 10, an input shaft 20 rotatably installed in the housing 10, a first output shaft 50, and a second output shaft (not shown). The first output shaft 50 is arranged coaxially with the input shaft 20, and the second output shaft is not arranged coaxially with the first output shaft 50, but is arranged parallel and spaced apart from it. The first output shaft 50 transmits the driving force of the input shaft 20 to the primary drive wheels, and the second output shaft transmits the driving force of the input shaft 20 to the secondary drive wheels. The driving force of the input shaft 20 is always transmitted to the first output shaft 50, but is selectively transmitted to the second output shaft depending on whether a clutch 60 is pressed by the operation of a ball ramp 900, which will be described later.

A planetary gear 30 is arranged on the outside of the input shaft 20 to amplify the torque of the input shaft 20 transmitted to the first output shaft 50. Furthermore, a sleeve 40 is installed on the first output shaft 50 so as to be axially movable and to rotate in engagement with the first output shaft 50. At this time, the sleeve 40 can be coupled to the input shaft 20 or the planetary gear 30 while moving axially, thereby enabling high-low switching. Specifically, when the sleeve 40 is coupled to the input shaft 20, it corresponds to high mode, and when the sleeve 40 is coupled to the planetary gear 30, it corresponds to low mode. In low mode, the torque of the input shaft 20, i.e., the driving force, is amplified by the gear ratio of the planetary gear 30 and transmitted to the first output shaft 50.

The sleeve 40 is coupled to a fork 600 described below and moves axially as a single unit, which will be discussed in detail below.

The first output shaft 50 and the second output shaft are connected by a chain (not shown), and the clutch 60 is arranged between the first output shaft 50 and the chain, so that the rotation of the first output shaft 50 is selectively transmitted to the chain according to the pressing force of the clutch 60. That is, the first clutch plates of the clutch 60 are connected to the first output shaft 50, and the second clutch plates, which are alternately arranged with the first clutch plates of the clutch 60, are connected to the chain, so that the driving force of the first output shaft 50 is transmitted to the chain and ultimately to the second output shaft only when the clutch 60 is pressed. When the driving force of the input shaft 20 is transmitted only to the first output shaft 50, it corresponds to a 2WD state in which only the main drive wheels are driven. When the driving force of the input shaft 20 is transmitted to both the first output shaft 50 and the second output shaft, it corresponds to a 4WD state in which both the primary drive wheels and the secondary drive wheels are driven.

The clutch 60 is pressurized by the axial stroke generated by the ball ramp 900 described below, which will be examined in detail below.

Below, with reference to FIGS. 2 to 9, we will focus on the actuating configurations for performing both the function of axially moving the sleeve 40 for high-low switching (i.e., the axial movement function of the fork (600)) and the function of controlling the pressure of the clutch 60 for 2WD-4WD switching (i.e., the operation function of the ball ramp 900) using a single actuator.

The 2-speed transfer case of the present embodiment includes, as actuating configurations, a motor 100, a reduction unit 150, a reduction gear 200, a cam shaft 250, a lever cam 300, a torsion spring unit 400, a cylindrical cam 500, a fork 600, a position sensor 700, a cam gear 800, and a ball ramp 900.

The present disclosure uses a BLAC motor 100 with a built-in MR sensor that measures the rotation angle of the motor as a single actuator.

The reduction unit 150 is connected to the motor 100 to amplify the torque of the motor 100. In the present embodiment, the reduction unit 150 is illustrated as a spur gear set, but is not limited thereto, and the reduction unit may be a worm gear.

The reduction gear 200 is connected to the reduction unit 150. In the present embodiment, since the reduction unit 150 corresponds to a spur gear set, the reduction gear 200 is connected to the last spur gear of the spur gear set.

The cam shaft 250 is coupled to the center of the reduction gear 200 and rotates integrally with it. A lever cam 300 is also installed on the cam shaft 250 and rotates integrally with it. The lever cam 300 is spaced apart from the reduction gear 200 on the cam shaft 250. In this way, the reduction gear 200, the cam shaft 250, and the lever cam 300 all rotate integrally.

A cylindrical cam 500 is installed coaxially with the lever cam 300 on the cam shaft 250, but the cylindrical cam 500 does not rotate integrally with the cam shaft 250 but is installed in a state in which it can rotate relatively to it. At this time, as the torsion spring unit 400 is placed between the lever cam 300 and the cylindrical cam 500, the rotation of the lever cam 300 can be transmitted to the cylindrical cam 500 by the torsion spring unit 400.

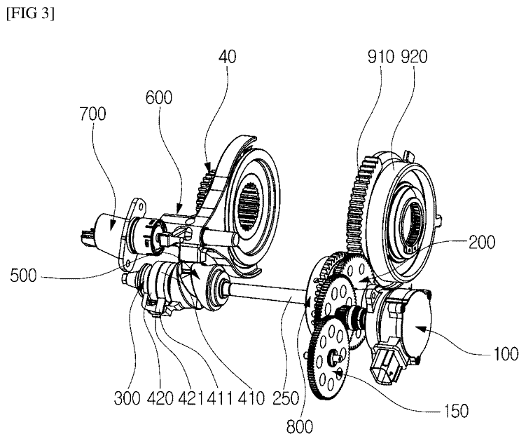

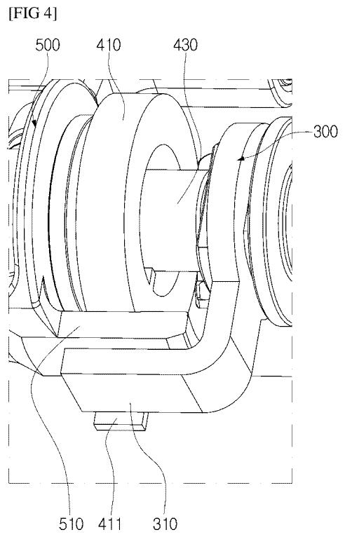

Referring to FIGS. 3 and 4, the torsion spring unit 400 of the present embodiment will be described in detail. The torsion spring unit 400 includes a first torsion spring 410 and a second torsion spring 420 that are arranged coaxially and in parallel, and a bushing 430 that connects the first torsion spring 410 and the second torsion spring 420.

In the present embodiment, the first torsion spring 410 is arranged on the cylindrical cam 500 side, and the second torsion spring 420 is arranged on the lever cam 300 side, but embodiments are not limited thereto. The bushing 430 is formed in a cylindrical shape and connects the first torsion spring 410 and the second torsion spring 420 on the inside.

At this time, one directional rotation of the lever cam 300 causes one directional rotation of the first torsion spring 410, and the other-directional rotation of the lever cam 300 causes the other-directional rotation of the second torsion spring 420. In addition, one directional rotation of the second torsion spring 420 causes one directional rotation of the cylindrical cam 500, and the other-directional rotation of the first torsion spring 410 causes the other-directional rotation of the cylindrical cam 500.

Accordingly, when the lever cam 300 rotates in one direction, the first torsion spring 410 rotates in one direction, and unless in a butting state described later, the second torsion spring 420 rotates in one direction by the same amount as the first torsion spring 410, so that the cylindrical cam 500 also rotates in one direction. Conversely, when the lever cam 300 rotates in the other direction, the second torsion spring 420 rotates in the other direction, and similarly, unless in a butting state, the first torsion spring 410 rotates in the other direction by the same amount as the second torsion spring 420, thereby causing the cylindrical cam 500 to also rotate in the other direction.

To this end, the lever cam 300 includes a first bending portion 310 that protrudes radially outward and is bent toward the cylindrical cam 500, and the cylindrical cam 500 includes a second bending portion 510 that protrudes radially outward and is bent toward the lever cam 300. In the present embodiment, the second bending portion 510 is positioned radially inward of the first bending portion 310, but the embodiments of the present disclosure are not limited thereto.

In addition, the first torsion spring 410 includes a first extension portion 411 that extends to face both one side of the first bending portion 310 and one side of the second bending portion 510, and the second torsion spring 420 includes a second extension portion 421 that extends to face both the other side of the first bending portion 310 and the other side of the second bending portion 510.

Accordingly, when the lever cam 300 rotates in one direction, the first bending portion 310 pushes the first extension portion 411, causing the first torsion spring 410 to rotate in one direction, and when the lever cam 300 rotates in the other direction, the first bending portion 310 pushes the second extension portion 421, causing the second torsion spring 420 to rotate in the other direction.

In addition, when the second torsion spring 420 rotates in one direction in the same manner as the first torsion spring 410, the second extension portion 421 pushes the second bending portion 510, causing the cylindrical cam 500 to rotate in one direction. When the first torsion spring 410 rotates in the other direction in the same manner as the second torsion spring 420, the first extension portion 411 pushes the second bending portion 510, causing the cylindrical cam 500 to rotate in the other direction.

The fork 600 is installed in the cam groove 520 of the cylindrical cam 500, and as the cylindrical cam 500 rotates, the fork 600 moves axially along the cam groove 520. Specifically, the cam groove 520 has straight sections at both ends along the circumference, and an inclined section formed between the straight sections at both ends. Accordingly, the fork 600 does not move axially in the straight sections at both ends, but moves axially only in the inclined section in the middle. That is, only in the inclined section in the middle, the fork 600 and the sleeve 40 integrally connected thereto move axially, thereby enabling high-low switching.

At this time, the present embodiment includes the position sensor 700 that detects the axial position of the fork 600. The position sensor 700 can be installed in the housing 10 of the two-speed transfer case, as illustrated in FIG. 1. Furthermore, considering space and the shape of the fork 600, which will be described later, the position sensor 700 is preferably positioned parallel to the cylindrical cam 500. In this embodiment, the position sensor 700 can detect the axial stroke of the fork 600, and ultimately, the axial position of the fork 600 can be detected through the axial stroke. In this way, the present disclosure can accurately determine the position of the fork 600 by directly detecting the position of the fork 600 moving in the axial direction for high-low switching through the position sensor 700.

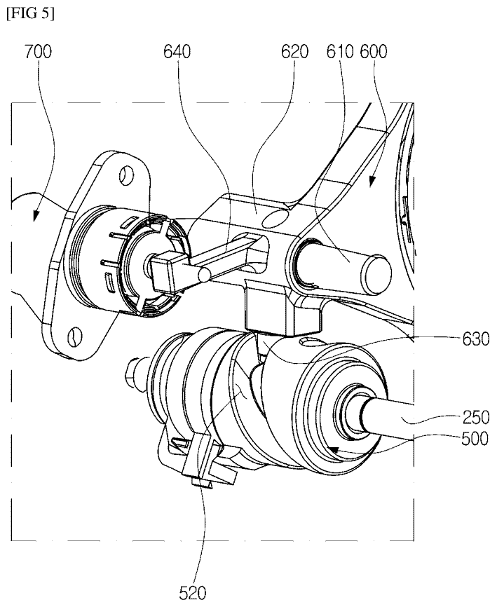

As illustrated in FIG. 5, the fork 600 specifically includes a body portion 620 that is installed axially movable on a fork shaft 610 that is spaced apart from and parallel to the cam shaft 250, a cam protrusion 630 that protrudes from the body portion 620 toward the cylindrical cam 500 so as to be positioned within the cam groove 520 of the cylindrical cam 500, and a position protrusion 640 that protrudes from the body portion 620 toward the position sensor 700.

Since the position protrusion 640 protrudes from the body portion 620 in a different direction from the cam protrusion 630, similar to the cam protrusion 630, the shape deformation of the fork 600 for the position sensor 700 is not significant.

Next, the cam gear 800 is installed coaxially with the reduction gear 200 on the cam shaft 250, but the cam gear 800 is installed in a state where it can rotate relatively to the cam shaft 250 rather than rotating integrally with it. The cam gear 800 only engages with the reduction gear 200 during a certain rotational range and rotates together with it, and in the non-engaging rotational range, the cam gear 800 does not rotate despite the rotation of the reduction gear 200.

The ball ramp 900 is engaged with the cam gear 800 and operates according to the rotation of the cam gear 800, generating an axial stroke for pressurizing the clutch 60. The ball ramp 900 may specifically include a first ball ramp plate 910, a second ball ramp plate 920, and a ball that rolls and is interposed between the first and second ball ramp plates 910, 920. The first and second ball ramp plates 910, 920 have grooves that gradually become shallower in both directions, so that when the cam gear 800 rotates either of the first and second ball ramp plates 910, 920, the ball changes from a deep position to a shallow position in the ball groove, thereby generating an axial stroke.

Specifically, in the rotation section of the reduction gear 200 where the fork 600 moves axially, the reduction gear 200 and the cam gear 800 do not engage, and in the rotation section of the reduction gear 200 where the fork 600 does not move axially, the reduction gear 200 and the cam gear 800 engage. That is, in the straight sections at both ends of the cam groove 520, since the fork 600 does not move axially, the reduction gear 200 and the cam gear 800 will engage and rotate together, and in the middle inclined section of the cam groove 520, since the fork 600 moves axially, the reduction gear 200 and the cam gear 800 will not engage, and the cam gear 800 will not rotate. Accordingly, high-low switching and 2WD-4WD switching can be performed at different rotation intervals.

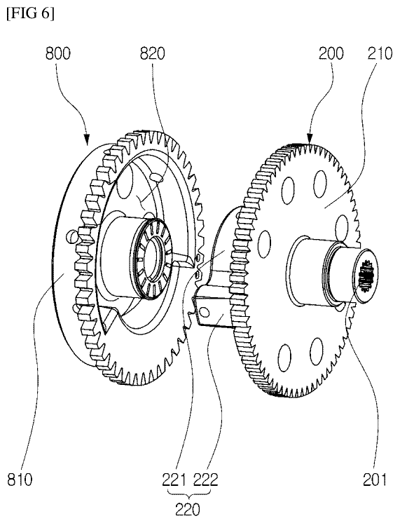

Referring to FIG. 6, the structure of the reduction gear 200 and the cam gear 800 will be examined in more detail. The reduction gear 200 includes a plate 210 on the outer periphery of which a gear that engages with the reduction unit 150 is formed, and a protrusion portion 220 that protrudes from the plate 210 toward the cam gear 800. In the present embodiment, the protrusion portion 220 includes a central circular portion 221 and a catching portion 222 that extends radially outward from the circular portion 221, but the embodiments of the present disclosure are not limited thereto, and it is obvious that only the catching portion 222 may be formed.

The cam gear 800 includes a cylindrical portion 810 on the outer periphery of which a gear engaging with a ball ramp 900 is formed, and a space portion 820 formed circumferentially within the cylindrical portion 810 with respect to the rotational section of the reduction gear 200 in which the fork 600 moves axially and in which the protrusion portion 220 is accommodated.

The space portion 820 is formed circumferentially with respect to the rotational section of the reduction gear 200 in which the fork 600 moves axially, but both ends are closed. Accordingly, when the catching portion 222 rotates within the space portion 820, it does not engage with the cam gear 800 and does not rotate the cam gear 800, but when the catching portion 222 comes into contact with the closed ends of the space portion 820, it engages and rotates the cam gear 800 together.

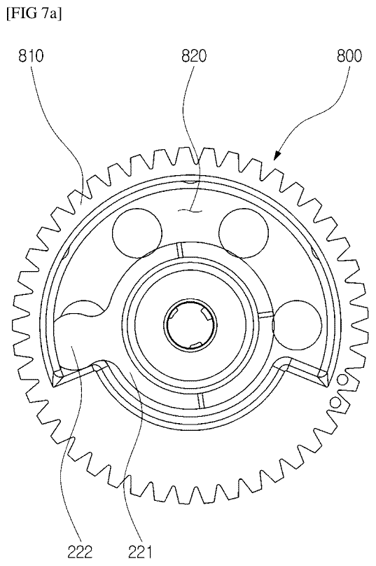

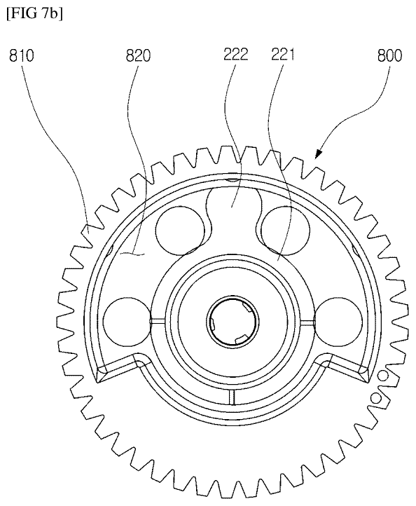

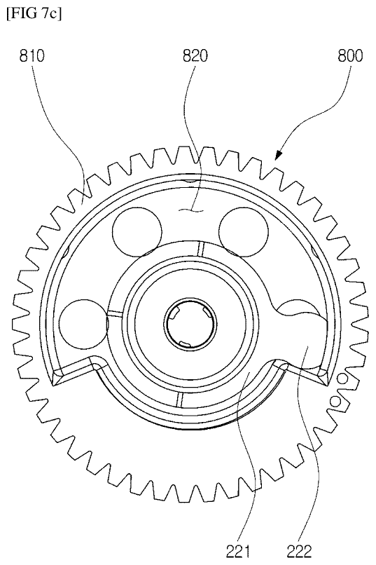

FIG. 7a illustrates a state in which the catching portion 222 of the reduction gear 200 is engaged with one end of the space portion 820, FIG. 7b illustrates a state in which the catching portion 222 is located in the middle of the space portion 820 and is not engaged, and FIG. 7c illustrates a state in which the catching portion 222 is engaged with the other end of the space portion 820. FIG. 7a corresponds to the high mode, FIG. 7b corresponds to the process of switching from the high mode to the low mode, and FIG. 7c may correspond to the low mode.

In this way, when the fork 600 moves axially and switches between high and low, the cam gear 800 does not rotate and the ball ramp 900 does not operate. When the high-low switching is completed and the fork 600 does not move axially, the cam gear 800 engaged with the reduction gear 200 rotates and the ball ramp 900 operates. When the ball ramp 900 operates, an axial stroke is generated, so that the clutch 60 is pressed and the mode can be switched from 2WD mode to 4WD mode.

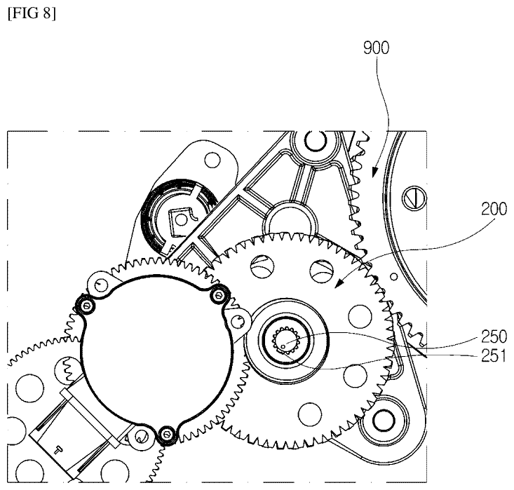

Referring to FIGS. 6 and 8, in order to align the cam shaft 250 and the reduction gear 200 when the rotation angle of the motor 100 is 0°, the cam shaft 250 may be provided with a tooth alignment protrusion 251, and the reduction gear 200 may be provided with a tooth alignment groove 201 into which the tooth alignment protrusion 251 is inserted.

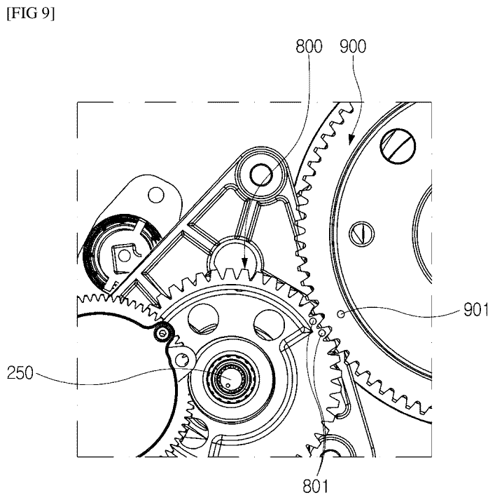

Also, referring to FIG. 9, in order to align the cam gear 800 and the ball ramp 900 when the rotation angle of the motor 100 is 0°, the cam gear 800 and the ball ramp 900 may be provided with tooth alignment marks 801, 901, respectively. Through this, when assembling the cam gear 800 and the ball ramp 900, the worker can easily assemble them so that the alignment mark 801 of the cam gear 800 and the alignment mark 901 of the ball ramp 900 face each other.

In the present embodiment, when the rotation angle of the motor 100 is 0°, the components are aligned to correspond to the high mode and 2WD mode. That is, when the rotation angle of the motor 100 is 0°, the reduction gear 200, the cylindrical cam 500, the fork 600, the cam gear 800, and the ball ramp 900 are aligned in a state where the ball ramp 900 is not operated and no axial stroke occurs, and the fork 600 is positioned furthest from the ball ramp 900. More specifically, the fork 600 will be positioned at the beginning of the straight section corresponding to the high mode among the straight sections at both ends of the cam groove 520, and the catching portion 222 will be positioned in contact with one end of the space portion 820, as shown in FIG. 7a. Accordingly, the assembly and phase matching accuracy of the 2-speed transfer case can be improved.

Since the present embodiment includes the MR sensor of the motor 100 and position sensor 700 as described above, the butting or failure status of the 2-speed transfer case can be accurately identified by determining the angular difference before and after the torsion spring unit 400.

To this end, the 2-speed transfer case of the present embodiment further includes a control unit that determines a butting state in which the rotation of the lever cam 300 is not completely transferred to the rotation of the cylindrical cam 500 or a malfunction state of the 2-speed transfer case by using the rotation angle of the motor 100 measured by the MR sensor and the axial position of the fork 600 detected by the position sensor 700.

The butting state refers to a state in which the sleeve 40 is not fastened to the input shaft 20 or the planetary gear 30 and the sleeve 40 cannot move smoothly, and as a result, the cylindrical cam 500 also cannot rotate smoothly, and thus the rotational force of the lever cam 300 is received by the torsion spring unit 400.

Specifically, the control unit calculates the rotation angle of the reduction gear 200 by considering the rotation angle of the motor 100 and the gear ratio from the motor 100 to the reduction gear 200, calculates the rotation angle of the cylindrical cam 500 through the axial stroke of the fork 600 detected by the position sensor 700, and then compares the rotation angle of the reduction gear 200 with the rotation angle of the cylindrical cam 500. Here, the rotation angle of the reduction gear 200 is the same as the rotation angle of the lever cam 300.

At this time, since the stroke per angle of the cam groove 520 of the cylindrical cam 500 will be determined, the rotation angle of the cylindrical cam 500 can be calculated through the axial stroke of the fork 600. For example, if the stroke per angle of the cam groove 520 of the cylindrical cam 500 is 8.38 deg/mm, and the fork 600 has moved a stroke of 21 mm, the rotation angle of the cylindrical cam 500 can be calculated to be approximately 176°.

In this way, by comparing the rotation angle of the reduction gear 200 arranged before the torsion spring unit 400 and the rotation angle of the cylindrical cam 500 arranged after the torsion spring unit 400, it is possible to accurately determine whether the rotational force of the lever cam 300 is being received by the torsion spring unit 400 and not being completely transmitted to the cylindrical cam 500, or whether the rotational force of the lever cam 300 is not being received by the torsion spring unit 400 and is being completely transmitted to the cylindrical cam 500.

Specifically, the control unit determines that the transfer case is in a normal state if there is no difference between the rotation angle of the reduction gear 200 and the rotation angle of the cylindrical cam 500 during the rotation section of the reduction gear 200 in which the fork 600 moves in the axial direction. On the other hand, if the difference between the rotation angle of the reduction gear 200 and the rotation angle of the cylindrical cam 500 is 5° or more and 160° or less, the control unit determines that the transfer case is in a butting state, and if the difference between the rotation angle of the reduction gear 200 and the rotation angle of the cylindrical cam 500 exceeds 160°, the control unit can determine that the transfer case is in a fault state.

Consequently, if the control unit determines that a butting condition exists, the occurrence of the butting can be displayed on the vehicle's cluster to notify the driver. Specifically, to suggest the optimal butting release method, the butting section can be subdivided and different release methods can be displayed for each section.

For example, if the engagement is determined to be less than 5% of the spline length, i.e., a collision with the chamfer of the spline is determined, the phrase “Shift to D-gear and drive the vehicle” can be displayed on the vehicle's cluster. If the engagement is determined to be greater than 5% but less than 70% of the spline length, i.e., a collision with the side of the spline is determined, the phrase “Shift back to N-gear” can be displayed on the vehicle's cluster.

Additionally, if the control unit determines that a malfunction has occurred, the vehicle's warning light can be illuminated to notify the driver.

Furthermore, the control unit can determine that the transfer case is in a normal state if there is no difference between the rotation angle of the reduction gear 200 and the rotation angle of the cylindrical cam 500 during the rotation section of the reduction gear 200 where the fork 600 does not move axially, and can determine that there is a malfunction if the difference between the rotation angle of the reduction gear 200 and the rotation angle of the cylindrical cam 500 is 12° or more. Similarly, if the control unit determines that there is a malfunction, the vehicle warning light can be turned on to notify the driver.

In this way, not only can the butting state be determined during high-low switching, but even after normal engagement, the presence of component malfunction can be determined by continuously comparing the rotation angle of the reduction gear 200 and the rotation angle of the cylindrical cam 500 in real time while the vehicle is in operation. That is, after normal engagement, it is possible to diagnose whether damage occurs in the switching component at the rear end of the torsion spring unit 400 through continuous monitoring while the vehicle is in operation.

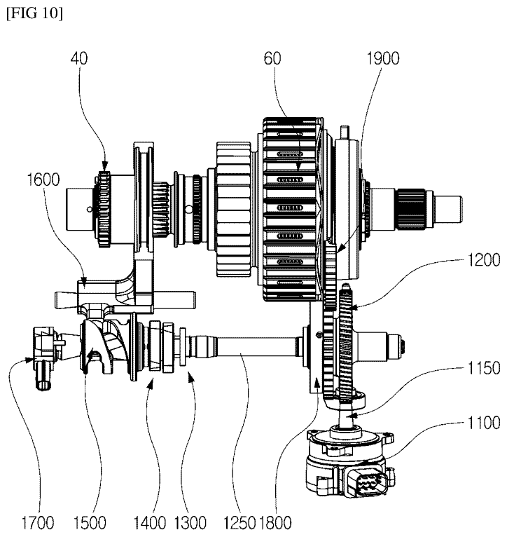

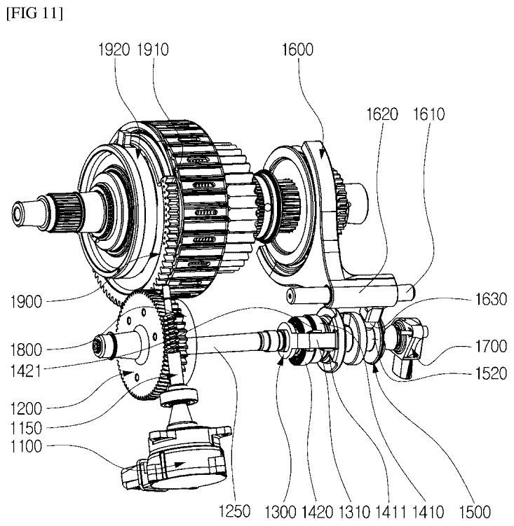

Next, a two-speed transfer case according to another embodiment of the present disclosure will be described with reference to FIGS. 10 and 11.

Since this embodiment differs from the embodiments described in FIGS. 1 to 9 in only some of its actuating components, the description will focus on the actuating components.

The two-speed transfer case of this embodiment includes actuating components such as a motor 1100, a reduction unit 1150, a reduction gear 1200, a cam shaft 1250, a lever cam 1300, a torsion spring unit 1400, a cylindrical cam 1500, a fork 1600, an angle sensor 1700, a cam gear 1800, and a ball ramp 1900.

The motor 1100 is a BLAC motor 1100 that also has a built-in MR sensor that measures the rotation angle of the motor.

The reduction unit 1150 is connected to the motor 1100 to amplify the torque of the motor 1100. In the present embodiment, the reduction unit 1150 corresponds to a worm gear, which causes the reduction gear 1200 to function as a worm wheel. However, this is not limited thereto, and the reduction unit may be a spur gear set.

As described above, the reduction gear 1200, cam shaft 1250, and lever cam 1300 all rotate as one unit, and the cylindrical cam 1500 is installed on the lever cam 1300 with the torsion spring unit 1400 interposed between them, so that the cylindrical cam 1500 is transmitted the rotation of the lever cam 1300 by the torsion spring unit 1400.

The specific configuration of the torsion spring unit 1400 is the same as described above. That is, as illustrated, the torsion spring 1400 includes a first torsion spring 1410 having a first extension portion 1411, a second torsion spring 1420 having a second extension portion 1421, and a bushing. Additionally, the lever cam 1300 includes a first bending portion 1310, and although not shown in detail, the cylindrical cam 1500 likewise includes a second bending portion.

At this time, the present embodiment includes an angle sensor 1700 that measures the rotation angle of the cylindrical cam 1500. The angle sensor 1700 is coaxially connected to the cylindrical cam 1500 and can directly measure the rotation angle of the cylindrical cam 1500. To this end, the lever cam 1300 and the torsion spring portion unit 1400 are arranged closer to the reduction gear 1200 than to the cylindrical cam 1500, and the angle sensor 1700 can be arranged at one end of the cylindrical cam 1500. That is, the angle sensor 1700 is arranged farther from the reduction gear 1200 than to the cylindrical cam 1500. In this way, the present disclosure can directly determine the rotation angle of the cylindrical cam 1500 through the angle sensor 1700, thereby enabling the accurate positioning of the fork 1600 that moves axially for high-low switching.

The fork 1600 is installed in the cam groove 1520 of the cylindrical cam 1500, and as the cylindrical cam 1500 rotates, the fork 1600 moves axially along the cam groove 1520. At this time, the fork 1600 specifically includes a body portion 1620 that is installed axially movable on a fork shaft 1610 that is spaced apart from and parallel to the cam shaft 1250, and a cam protrusion 1630 that protrudes from the body portion 1620 toward the cylindrical cam 1500 so as to be positioned within a cam groove 1520 of the cylindrical cam 1500, but does not include a position sensor, and therefore does not include the position protrusion described above.

In addition, the configuration of the cam gear 1800 and the ball ramp 1900 is the same as described above, so a detailed description will be omitted. FIG. 11 illustrates the first ball ramp plate 1910 and the second ball ramp plate 1920 of the ball ramp 1900.

Although not specifically illustrated, in order to align the cam shaft 1250 and the reduction gear 1200 when the rotation angle of the motor 1100 is 0°, as described above, the cam shaft 1250 may be provided with a tooth alignment protrusion, and the reduction gear 1200 may be provided with a tooth alignment groove into which the tooth alignment protrusion is inserted. In addition, in order to align the cam gear 1800 and the ball ramp 1900 when the rotation angle of the motor 1100 is 0°, the cam gear 1800 and the ball ramp 1900 may each be provided with a tooth alignment mark.

Since the present embodiment includes the MR sensor of the motor 1100 and the angle sensor 1700, the butting or failure status of the 2-speed transfer case can be accurately identified by determining the angle difference before and after the torsion spring unit 1400.

To this end, the present disclosure further includes a control unit that uses the rotation angle of the motor 1100 measured by the MR sensor and the rotation angle of the cylindrical cam 1500 measured by the angle sensor 1700 to determine a butting state in which the rotation of the lever cam 1300 is not completely transferred to the rotation of the cylindrical cam 1500 or a malfunction state of the 2-speed transfer case.

Specifically, the control unit calculates the rotation angle of the reduction gear 1200 by considering the rotation angle of the motor 1100 and the gear ratio from the motor 1100 to the reduction gear 1200, and then compares the rotation angle of the reduction gear 1200 with the rotation angle of the cylindrical cam 1500. Here, the rotation angle of the reduction gear 1200 is equal to the rotation angle of the lever cam 1300.

In this way, by comparing the rotation angle of the reduction gear 1200 arranged before the torsion spring unit 1400 and the rotation angle of the cylindrical cam 1500 arranged after the torsion spring unit 1400, it is possible to accurately determine whether the rotational force of the lever cam 1300 is being received by the torsion spring unit 1400 and not being completely transmitted to the cylindrical cam 1500, or whether the rotational force of the lever cam 1300 is not being received by the torsion spring unit 1400 and is being completely transmitted to the cylindrical cam 1500.

In particular, unlike the above, the present embodiment includes an angle sensor 1700 that directly measures the rotation angle of the cylindrical cam 1500, rather than a position sensor. Therefore, a process of converting the axial position of the fork 1600 into the rotation angle of the cylindrical cam 1500 is not necessary.

The following description of how the control unit compares the rotation angle of the reduction gear 1200 with the rotation angle of the cylindrical cam 1500 to determine a butting or malfunction state is the same as described above.

In other words, the control unit determines that the transfer case is in a normal state if there is no difference between the rotation angle of the reduction gear 1200 and the rotation angle of the cylindrical cam 1500 during the rotation section of the reduction gear 1200 in which the fork 1600 moves axially. On the other hand, if the difference between the rotation angle of the reduction gear 1200 and the rotation angle of the cylindrical cam 1500 is 5° or more and 160° or less, it is determined to be in a butting state, and if the difference between the rotation angle of the reduction gear 1200 and the rotation angle of the cylindrical cam 1500 exceeds 160°, it can be determined to be in a fault state.

Furthermore, the control unit can determine that the transfer case is in a normal state if there is no difference between the rotation angle of the reduction gear 1200 and the rotation angle of the cylindrical cam 1500 in the rotation section of the reduction gear 1200 in which the fork 1600 does not move axially, and if the difference between the rotation angle of the reduction gear 1200 and the rotation angle of the cylindrical cam 1500 is 12° or more, it can be determined to be in a fault state.

Although the present disclosure has been described with reference to the exemplified drawings, it is to be understood that the present disclosure is not limited to the embodiments and drawings disclosed in this specification, and those skilled in the art will appreciate that various modifications are possible without departing from the scope and spirit of the present disclosure. Further, although the operating effects according to the configuration of the present disclosure are not explicitly described while describing an embodiment of the present disclosure, it should be appreciated that predictable effects are also to be recognized by the configuration.

### NUMERAL REFERENCES

10: Housing
20: Input shaft
30: Planetary gear
40: Sleeve
50: First output shaft
60: Clutch
100, 1100: Motor
150, 1150: Reduction unit
200, 1200: Reduction gear
201: Tooth alignment groove
210: Plate
220: Protrusion portion
221: Circular portion
222: Catching portion
250, 1250: Cam shaft
251: Tooth alignment protrusion
300, 1300: Lever cam
310, 1310: First bending portion
400, 1400: Torsion spring portion
410, 1410: First torsion spring
411, 1411: First extension portion
420, 1420: Second torsion spring
421, 1421: Second extension portion
430: Bush
500, 1500: Cylindrical cam
510: Second bending portion
520, 1520: Cam groove
600, 1600: Fork
610, 1610: Fork shaft
620, 1620: Body portion
630, 1630: Cam protrusion
640: Position protrusion
700: Position sensor
800, 1800: Cam gear
801: Tooth alignment mark
810: Cylindrical portion
820: Space portion
900, 1900: Ball ramp
901: Tooth alignment mark
910, 1910: First ball ramp plate
920, 1920: Second ball ramp plate
1700: Angle sensor

1. A 2-speed transfer case comprising:
a motor comprising an MR sensor that is embedded therein configured to measure the rotational angle of a motor;
a reduction unit connected to the motor;
a reduction gear connected to the reduction unit;
a camshaft coupled to the center of the reduction gear and rotating integrally with the reduction gear;
a lever cam installed on the cam shaft and rotating integrally with the cam shaft;
a cylindrical cam installed coaxially with the lever cam;
a torsion spring unit disposed between the lever cam and the cylindrical cam and configured to transmit the rotation of the lever cam to the cylindrical cam;
a fork configured to move axially along a cam groove of the cylindrical cam; and
an angle sensor configured to measure the rotational angle of the cylindrical cam.

2. The 2-speed transfer case of claim 1, wherein the torsion spring unit comprises a first torsion spring and a second torsion spring that are arranged coaxially in parallel, and a bushing configured to connect the first torsion spring and the second torsion spring.

3. The 2-speed transfer case of claim 2, wherein the bushing is formed in a cylindrical shape and is disposed inside the first torsion spring and the second torsion spring.

4. The 2-speed transfer case of claim 2, wherein one directional rotation of the lever cam causes one directional rotation of the first torsion spring and the other-directional rotation of the lever cam causes the other-directional rotation of the second torsion spring, and
one directional rotation of the second torsion spring causes one directional rotation of the cylindrical cam and the other-directional rotation of the first torsion spring causes the other-directional rotation of the cylindrical cam.

5. The 2-speed transfer case of claim 4, wherein the lever cam comprises a first bending portion that protrudes radially outward and is bent toward the cylindrical cam, and the cylindrical cam comprises a second bending portion that protrudes radially outward and is bent toward the lever cam, and
the first torsion spring comprises a first extension portion that extends to face both one side of the first bending portion and one side of the second bending portion, and the second torsion spring comprises a second extension portion that extends to face both the other side of the first bending portion and the other side of the second bending portion.

6. The 2-speed transfer case of claim 1, wherein the angle sensor is coaxially connected to the cylindrical cam.

7. The 2-speed transfer case of claim 6, wherein the lever cam and the torsion spring portion are arranged closer to the reduction gear than the cylindrical cam, and the angle sensor is arranged farther from the reduction gear than the cylindrical cam.

8. The 2-speed transfer case of claim 1, further comprising:
a cam gear arranged coaxially with the reduction gear and configured to rotate together with the reduction gear only during a certain rotational range; and
a ball ramp configured to operate according to the rotation of the cam gear and generate an axial stroke,
wherein in the rotation section of the reduction gear in which the fork moves axially, the reduction gear and the cam gear do not engage, and in the rotation section of the reduction gear in which the fork does not move axially, the reduction gear and the cam gear engage.

9. The 2-speed transfer case of claim 8, wherein the reduction gear comprises a plate having a gear formed on the outer periphery thereof to engage with the reduction unit, and a protrusion portion protruding from the plate toward the cam gear, and
the cam gear comprises a cylindrical portion having a gear formed on the outer periphery thereof to engage with the ball lamp, and a space portion formed inside the cylindrical portion in the circumferential direction with respect to the rotational section of the reduction gear in which the fork moves axially, and in which the protrusion is accommodated.

10. The 2-speed transfer case of claim 1, wherein the reduction unit is a worm gear.

11. The 2-speed transfer case of claim 1, wherein the reduction unit is a spur gear set.

12. The 2-speed transfer case of claim 1, further comprising:
a control unit configured to determine whether the 2-speed transfer case is in a butting state where the rotation of the lever cam is not completely transmitted to the rotation of the cylindrical cam or whether the 2-speed transfer case is in a failure state by using the rotation angle of the motor measured by the MR sensor and the rotation angle of the cylindrical cam measured by the angle sensor.

13. The 2-speed transfer case of claim 12, wherein the control unit calculates the rotation angle of the reduction gear by considering the rotation angle of the motor and the gear ratio from the motor to the reduction gear, and compares the rotation angle of the reduction gear with the rotation angle of the cylindrical cam.

14. The 2-speed transfer case of claim 13, wherein the control unit determines that the butting state is present if the difference between the rotation angle of the reduction gear and the rotation angle of the cylindrical cam is 5° or more and 160° or less in the rotation section of the reduction gear in which the fork moves in the axial direction.

15. The 2-speed transfer case of claim 14, wherein the control unit determines that the failure state is present if the difference between the rotation angle of the reduction gear and the rotation angle of the cylindrical cam exceeds 160° in the rotation section of the reduction gear in which the fork moves in the axial direction.

16. The 2-speed transfer case of claim 14, wherein if the control unit determines that the butting state is present, it displays the occurrence of butting on a vehicle's cluster.

17. The 2-speed transfer case of claim 15, wherein the control unit turns on the vehicle's warning light when it determines that the failure state is present.

18. The 2-speed transfer case of claim 13, wherein the control unit determines that the failure state is present if the difference between the rotation angle of the reduction gear and the rotation angle of the cylindrical cam is 12° or more in the rotation section of the reduction gear in which the fork does not move axially.

19. The 2-speed transfer case of claim 8, wherein in order to align the cam shaft and the reduction gear when the rotation angle of the motor is 0°, the cam shaft comprises a tooth alignment protrusion, and the reduction gear comprises a tooth alignment groove into which the tooth alignment protrusion is inserted.

20. The 2-speed transfer case of claim 8, wherein in order to align the cam gear and the ball ramp when the rotation angle of the motor is 0°, the cam gear and the ball ramp each comprises alignment marks.
